(19) United States
(12) Patent Application Publication
(10) Pub. No.: US 2020/0027238 A1
(43) Pub. Date: Jan. 23, 2020

(54) METHOD FOR MERGING IMAGES AND UNMANNED AERIAL VEHICLE

(71) Applicant: SZ DJI TECHNOLOGY CO., LTD., Shenzhen (CN)

(72) Inventors: Jiadi WANG, Shenzhen (CN); Yongsheng ZHANG, Shenzhen (CN); Xingyuan CHEN, Shenzhen (CN); Shanguang GUO, Shenzhen (CN)

(21) Appl. No.: 16/577,683

(22) Filed: Sep. 20, 2019

Related U.S. Application Data
(63) Continuation of application No. PCT/CN2017/077936, filed on Mar. 23, 2017.

(51) Int. Cl. G06T 7/73; B64C 39/02; G06T 7/32; G06T 7/00

(52) U.S. Cl. CPC G06T 7/73; B64C 39/024; B64C 2201/127; G06T 7/97; G06T 2207/20212; G06T 7/32

(57) ABSTRACT

The present disclosure provides a method for merging images. The method includes capturing N images by using N imaging devices of a UAV, N being an integer greater than 1; identifying an image of an occluding object in each image; and merging the N images based on the image of the occluding object in each image to obtain a merged image without the occluding object.

### CROSS-REFERENCE TO RELATED APPLICATION

This application is a continuation application of International Application No. PCT/CN2017/077936, filed on Mar. 23, 2017, the entire content of which is incorporated herein by reference.

### TECHNICAL FIELD

The present disclosure relates to the field of Unmanned Aerial Vehicle (UAV) technology, and more specifically, to a method for merging images and a UAV.

### BACKGROUND

A UAV may capture an image through an imaging device disposed on the UAV and present the image to a user through a display interface. Often, the imaging device is mounted on the UAV mainly through a gimbal disposed at the bottom of the UAV, and the imaging device may be carried on the gimbal. By using the gimbal, the stability of the imaging device of the UAV may be ensured during flight, and high quality images may be captured. However, currently the imaging device is carried on the gimbal located at the bottom of the UAV. It is likely for the imaging device to capture the image of the rotors of UAV in a captured image. As such, a portion of the image that needs to be captured may be blocked by the rotor, thereby affecting the image capturing effect.

### SUMMARY

The present disclosure provides a method for merging images and a UAV for avoiding capturing an image including an occlusion and improving the image capturing effect of the UAV.

One aspect of the present disclosure provides a method for merging images. The method includes: capturing N images by using N imaging devices of a UAV respectively, N being an integer greater than 1; identifying an image of an occluding object in each image; and merging the N images based on the image of the occluding object in each image to obtain a merged image without the occluding object.

Another aspect of the present disclosure provides an unmanned aerial vehicle (UAV). The UAV includes a frame; a first imaging device disposed at the top of the frame for capturing images; a second imaging device disposed at the bottom of the frame for capturing images; and a controller that is communicatively connected to the first imaging device and the second imaging device. Further, the first imaging device and the second imaging device are used to transmit captured images to the controller; and the controller is used to identify an image of an occluding object in each image, and merge the images based on the image of the occluding object in each image to obtain a merged image without the occluding object.

The image merging method and the UVA provided in the present disclosure may be used to obtain a merged image without the occlusion by using a plurality of imaging devices of the UAV to capture a plurality of images, identify the image of the occluding object in each image, and merge the plurality of images based on the image of the occluding object in each image. Therefore, the merged image obtained at the end may be a panoramic image without the interference of the occluding object, which may improve the image capturing effect.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic architectural diagram of an unmanned flight system according to an embodiment of the present disclosure;

FIG. 2 is a flowchart of an image merging method according to an embodiment of the present disclosure;

FIG. 3a to FIG. 3e are schematic diagrams of operations of the image merging method according to an embodiment of the present disclosure;

FIG. 4 is a schematic structural diagram of a UAV according to an embodiment of the present disclosure;

FIG. 5 is a schematic structural diagram of a frame of the UAV according to an embodiment of the present disclosure;

FIG. 6 is a schematic structural diagram of the UAV according to another embodiment of the present disclosure; and

FIG. 7 is a schematic structural diagram of the UAV according to still another embodiment of the present disclosure.

### DETAILED DESCRIPTION OF THE EMBODIMENTS

In order to make the objectives, technical solutions, and advantages of the present disclosure clearer, the technical solutions in the embodiments of the present disclosure will be described below with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

The embodiments of the present disclosure provide a method for merging images and a UAV. The following description of the present disclosure uses a drone as an example of the UAV. It will be apparent to those skilled in the art that other types of UAVs may be used without limitation, and embodiments of the present disclosure may be applied to various types of drones. For example, the drone may be a small drone or a large drone. In some embodiments, the drone may be a rotorcraft, such as a multi-rotor aircraft propelled by air by a plurality of propulsion devices. However, the embodiments of the present disclosure are not limited thereto, and the drone may be other types of drones or movable devices.

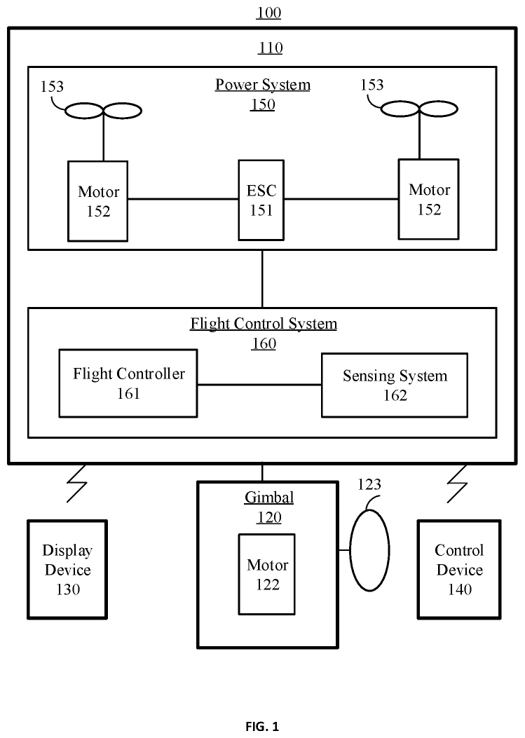

FIG. 1 is a schematic architectural diagram of an unmanned flight system according to an embodiment of the present disclosure. The present embodiment is described by taking a rotorcraft as an example.

The unmanned flight system 100 may include a UAV 110, a gimbal 120, a display device 130, and a control device 140. In particular, the UAV 110 may include a power system 150, a flight control system 160, and a frame. The UAV may communicate wirelessly with the control device 140 and the display device 130.

The frame may include a body and a stand (also known as a landing gear). The body may include a main frame and one or more arms connected to the main frame, the one or more arms may extend radially from the main frame. The stand may be attached to the body for supporting the landing of the UAV 110.

The power system 150 may include an Electronic Speed Controller (ESC) 151, one or more rotors 153, and one or more motors 152 corresponding to the one or more rotors 153. The motor 152 may be connected between the ESC 151 and the rotor 153, and the motor 152 and the rotor 153 may be disposed on the corresponding arm. The ESC 151 may be used to receive a drive signal generated by the flight control system 160 and provide a drive current to the motor 152 based on the drive signal to control the rotational speed of the motor 152. Motor 152 may be used to drive the rotation of the rotor to power the flight of the UAV 110, which allows the UAV 110 to achieve one or more degrees of freedom of motion. In some embodiments, the UAV 110 may be rotated about one or more rotating axes. For example, the rotating axes mentioned above may include a roll axis, a yaw axis, and a pitch axis. It should be understood that the motor 152 may be a DC motor or an AC motor. In addition, the motor 152 may be a brushless motor or a brush motor.

The flight control system 160 may include a flight controller 161 and a sensing system 162. The sensing system 162 may be used to measure the attitude information of the UAV, that is, the position information and state information of the UAV 110 in space. For example, a three-dimensional position, a three-dimensional angle, a three-dimensional velocity, a three-dimensional acceleration, a three-dimensional angular velocity, etc. The sensing system 170 may include, for example, one or more of a gyroscope, an electronic compass, an Inertial Measurement Unit (IMU), a vision sensor, a global navigation satellite system, and a barometer. For example, the global navigation satellite system may be a Global Positioning System (GPS). The flight controller 161 may be used to control the flight of the UAV 110, for example, the flight of the UAV 110 may be controlled based on the attitude information measured by the sensing system 162. It should be understood that flight controller 161 may control the UAV 110 based on pre-programmed computer executable instructions, or in response to one or more control commands from the control device 140.

The gimbal 120 may include a motor 122 and the gimbal 120 may be used to carry an imaging device 123. The flight controller 161 may control the motion of the gimbal 120 through the motor 122. In another embodiment, the gimbal 120 may also include a controller for controlling the motion of the gimbal 120 by controlling the motor 122. It should be understood that the gimbal 120 may be independent of the UAV 110 or may be a part of the UAV 110. It should be understood that the motor 122 may be a DC motor or an AC motor. In addition, the motor 122 may be a brushless motor or a brush motor. It should also be understood that the gimbal may be located at the top of the aircraft or at the bottom of the aircraft.

The imaging device 123 may be, for example, a device for capturing an image, such as a camera or a video camera. The imaging device 123 may communicate with the flight controller and perform image capturing under to control of the flight controller.

The display device 130 may be located at a ground end of the unmanned flight system 100. The display device 130 may communicate with the UAV 110 wirelessly and display the attitude information of the UAV 110. In addition, an image captured by the image capturing device may also be displayed on the display device 130. It should be understood that display device 130 may be a standalone device or may be disposed in the control device 140.

The control device 140 may be located at the ground end of the unmanned flight system 100 and may communicate with the UAV 110 wirelessly to remotely control the UAV 110.

It should be understood that the above-mentioned nomenclature of the components of the unmanned flight system is for the purpose of identification only and is not to be construed as limiting the embodiments of the disclosure.

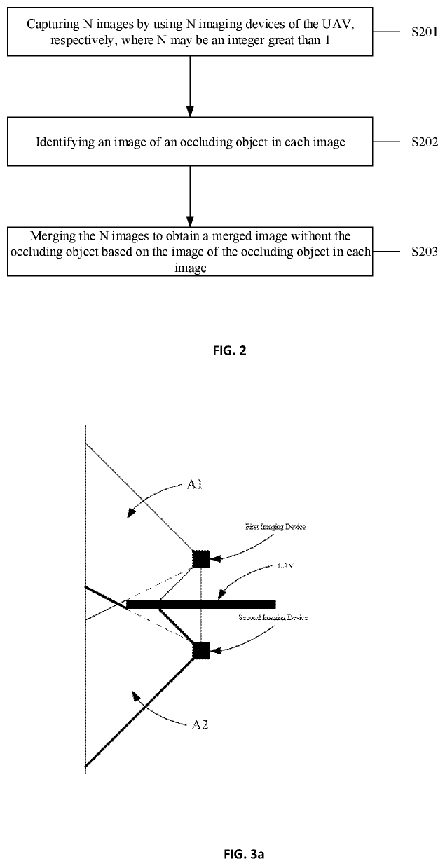

FIG. 2 is a flowchart of an image merging method according to an embodiment of the present disclosure. The method is described in more detail below.

S201, capturing N images by using N imaging devices of the UAV, respectively, where N may be an integer great than 1.

Presently, when an imaging device is capturing an image and there is an occluding object in the way, the image captured may have a blind spot, and the imaging device may not be able to capture a part blocked by the occluding object. For example, the rotors of the UAV may block a part of the field of view. Therefore, the UAV in the present embodiment may include N imaging devices where N may be an integer greater than 1. Each imaging device may capture an image, and N imaging devices may capture a total of N images. In the present embodiment, N images may be captured by using N imaging devices. In particular, the imaging device may be a camera, a camcorder, an infrared image detector, etc.

S202, identifying an image of an occluding object in each image.

In the present embodiment, after N images are captured, the image of the occluding object in each of the N images may be identified. In particular, each image may include one or more images of the occluding object, and one or more types of the occluding objects.

In one implementation method of S202, a feature analysis may be performed on each image to obtain feature information of each image, and the image of the occluding object may be identified based on the feature information. For example, if the feature information of the captured image includes feature information of the image of the occluding object, the image of the occluding object in the captured image may be identified.

In one implementation method of S202, whether each image includes the same image portion as a predetermined image in a library of predetermined images of the occluding objects may be identified; if it does, then the same image portion may be identified as the image of the occluding object.

S203, merging the N images to obtain a merged image without the occluding object based on the image of the occluding object in each image.

After identifying the image of the occluding object in each image, since a plurality of images are captured in S201, even though some images may include the image of the occluding object, other images may capture the image blocked by the occluding object. Therefore, N images may be merged, and the image of the occluding object identified in S202 may be deleted, thereby obtaining the merged image without the occluding object.

In the present embodiment, a merged image without the occluding object may be obtained by using a plurality of imaging devices of the UAV to capture a plurality of images, identifying the image of the occluding object in each image, and merging the plurality of images based on the image of the occluding object in each image. Therefore, the merged image obtained at the end may not include the interference of the occluding object, but an image that needs to be captured, which may improve the image capturing effect.

One implementation method of S203 mentioned above may include S2031 and S2032.

S2031, acquiring a partial image corresponding to the image of the occluding object in each image from the N images.

In the present embodiment, N images may be captured, and images of the occluding object may be captured in these images. However, images other than the original image in the N images may captured the image blocked by the occluding object. Therefore, in the present embodiment, the partial image may be referred to an image blocked by the occluding object when acquiring the partial image corresponding to the image of the occluding object in each image from the N images.

S2032, obtaining the merged image by merging the N images by replacing the corresponding image of the occluding object with the partial image.

In the present embodiment, after acquiring the partial image (i.e., the image blocked by the occlusion) corresponding image of the occluding object in each image, for each image, the corresponding image of the occluding object may be replaced with the partial image, and N images may be merged to obtain an image, which may be the merged image. Since the image of the occluding object has been replaced by an image that is blocked by the occluding object, the merged image obtained may not include the occluding object. Further, in the process of merging to obtain the merged image, duplicated images may also be removed.

In one embodiment, one implementation method of S2031 mentioned above may include: acquiring the same image portion of any two images of the N images; and obtaining the partial image corresponding to the image of the occluding object of another image in one image based on a positional relationship between the same image portion and the image of the occluding object in the any two images.

In the present embodiment, any two images of the N images may be compared to determine the same image portion of the two images, then the positional relationship between the image of the occluding object of each image and the same image portion may be determined, and the partial image corresponding to the image of the occluding object of another image may be obtained from one of the two images. For example, the any two images may be described by using a first image and a second image as an example, the first image and the second image may be compared to determine the same image portion in the first image and the second image. Subsequently, the positional relationship between the same image portion in the first image and the image of the occluding object in the first image may be determined, and the positional relationship between the same image portion in the second image and the image of the occluding object in the second image may be determined.

For example, if the same image portion in the first image is located on the left side of the image of the occluding object in the first image, then it may indicate that the image on the right side of the occluding object may be blocked, and it may be determined that the image located on the right side of the same image portion in the second image may be the partial image corresponding to the image of the occluding object. Further, if the same image portion in the second image is located at the top of the image of the occluding object in the second image, then it may indicate that the image located at the bottom of the occluding object may be blocked, and it may be determined that the image located at the bottom of the same image portion in the first image may be the partial image corresponding to the image of the occluding object. The above description is provided for illustrative purposes, and it should be noted that the present embodiment is not limited thereto.

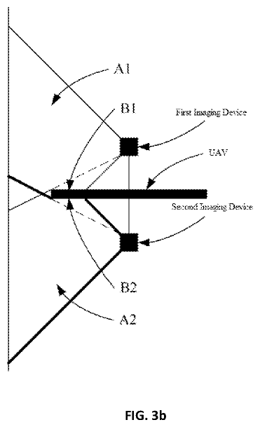

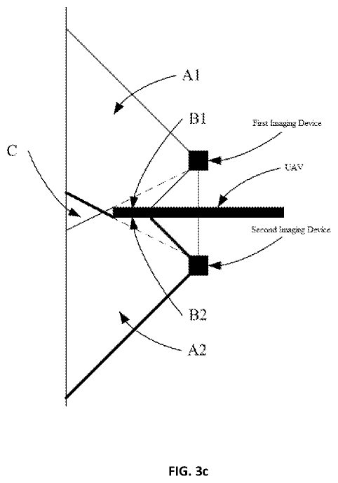

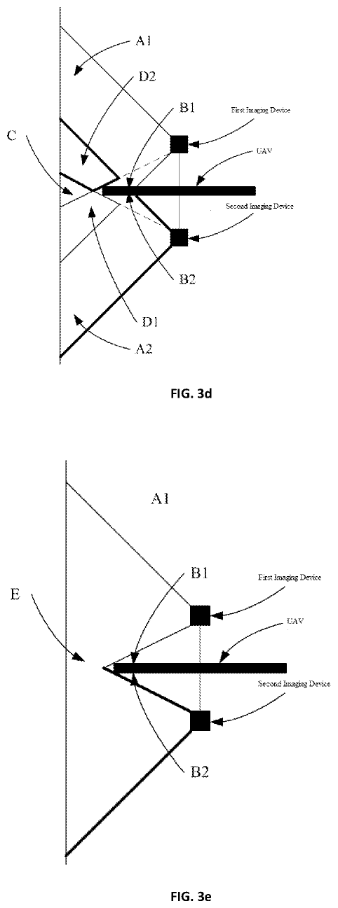

The present embodiment will be described in detail below with an example. FIG. 3a to FIG. 3e are schematic diagrams of operations of the image merging method according to an embodiment of the present disclosure. As shown in FIG. 3a-FIG. 3e, for example, N may be equal to 2, and the operating method when N is greater than 2 may be referred to the operating method when N is equal to 2. In particular, the two imaging devices may include a first imaging device and a second imaging device. The first imaging device may be located above the UAV, and the second imaging device may be located below the UAV. As shown in FIG. 3a, the first imaging device may be used to capture an image A1, and the second imaging device may be used to capture an image A2. As shown in FIG. 3b, the image of the occluding object in the image A1 may be identified as B1, and the image of the occluding object in the image A2 may be identified as B2. Further, as shown in FIG. 3c, the same image portion C in the image A1 and the image A2 may be acquired. As shown in FIG. 3d, a partial image D1 (i.e., the image blocked by the image of the occluding object B1) corresponding to the image B1 in the image A1 may be determined in the image A2, and a partial image D2 (i.e., the image blocked by the image of the occluding object B2) corresponding to the image B2 in the image A2 may be determined in the image A1 based on the positional relationship between the same image portion C and the image B1 in the image A1, and the positional relationship between the same image portion C and the image B2 in the image A2. As shown in FIG. 3e, the image B1 in the image A1 may be replaced with the partial image D1 in the image A2, the image B2 in the image A2 may be replaced with the partial image D2 in the image A1, and the image A1 may be merged with the image A2, where the same image portion C may be overlapped, thereby obtaining a merged image E, and the merged image E may not include the image B1 and the image B2. Therefore, the merged image obtained through the embodiment of the present disclosure may improve the image capturing effect.

In one embodiment, the N images may be images captured by the N imaging devices at the same time to ensure that the obtained merged image may be a panoramic image captured at the same time. Further, if the images are images in a video, the N images may be images corresponding to the same frame in the N videos.

In one embodiment, the N images may be images captured by the N imaging devices at the same heading angle.

In one embodiment, the N images may be images captured by the N imaging devices at the same time and at the same heading angle

In one embodiment, the image of the occluding object may include a portion or all of an image of one or more components of the UAV. Since the UAVs in the conventional technology may be equipped with an imaging device, the imaging device may capture a portion or all of the image of the components of the UAV while capturing images, which may block the image that may originally be needed to be captured, thereby affecting the image capturing effect. Therefore, the image of the occluding object in the present embodiment may include a part or all of the image of the components of the UAV, and the components may include one or more types of components.

In one embodiment, the components may include one or more of the following types: a rotor, an arm, a stand, and a body. The present embodiment provided four types of components of the UAVs, but the present embodiment is not limited thereto.

In one embodiment, the N imaging devices may be respectively carried on N gimbals of the UAV. To ensure the stability of the image captured by the imaging device during the flight of the UAV, N gimbals may be arranged on the UAV. Each gimbal may be used to carry an imaging device, and the gimbal may stably fix the imaging device to the UAV.

In one embodiment, the N gimbals may be arranged on the UAV around the center of the body of the UAV. Since a source of vibration of the UAV may be the rotors, N gimbals may be arranged around the center of the body of the UAV. As such, the gimbals may be as far away from the rotors as possible, and the image capturing effect of the imaging devices carried on the N gimbals may be more stable. In addition, by arranging the N gimbals around the center of the body of the UAV, the merged image obtained at the end may be a 360° omnidirectional image, thereby achieving a complete capturing of the spherical surface.

In one embodiment, a number of the N gimbals may be arranged at the bottom of the UAV, and other N gimbals may be arranged at the top of the UAV. As such, images of the arm and the rotors in the images captured by the imaging device may be avoided as much as possible.

In one embodiment, the method of the present embodiment may further include displaying the merged image on a display interface. As such, the user may view the merged image without the occluding object through the display interface in real time, which may improve the user's image capturing experience of the UAV.

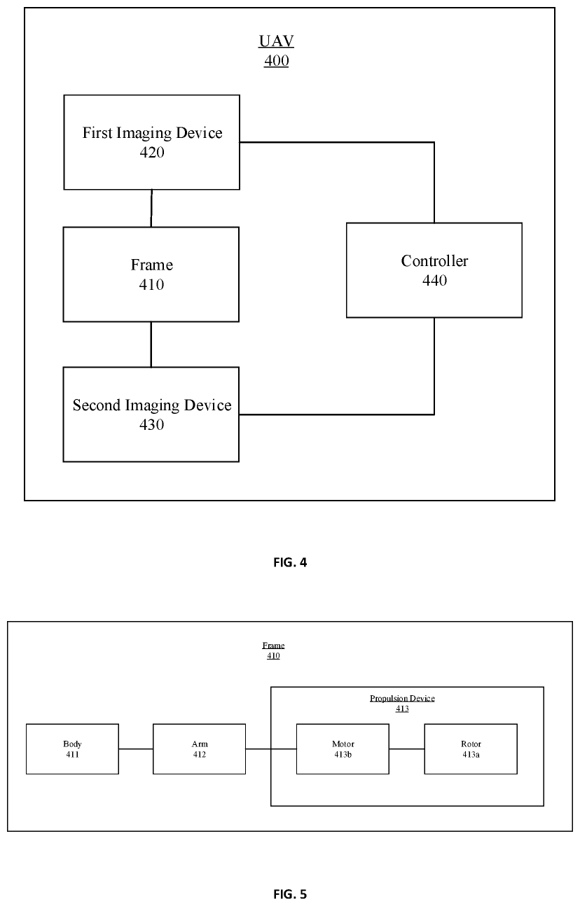

FIG. 4 is a schematic structural diagram of a UAV according to an embodiment of the present disclosure. As shown in FIG. 4, in one embodiment, a UAV 400 may include a frame 410, a first imaging device 420, a second imaging device 430, and a controller 440. The first imaging device 420 may be arranged at the top of the frame 410, and the second imaging device 430 may be arranged at the bottom of the frame 410. Further, the controller 440 may be communicatively connected to the first imaging device 420 and the second imaging device 430. Furthermore, the first imaging device 420 may include one or more imaging devices, and the second imaging device 430 may include one or more imaging devices. In FIG. 4, the first imaging device 420 and the second imaging device 430 are respectively illustrated as one imaging device, but the present embodiment is not limited thereto.

The first imaging device 420 and the second imaging device 430 may be used to capture images and transmit the captured images to the controller 440.

The controller 440 may be used to identify the image of the occluding object in each image, and merge the images based on the image of the occluding object in each image to obtain a merged image without the occluding object.

The UAV of the present embodiment may be used to perform the technical solutions provided in the foregoing method embodiments of the present disclosure. The implementation principles and technical effects thereof are similar, and details are not described herein again.

FIG. 5 is a schematic structural diagram of a frame of the UAV according to an embodiment of the present disclosure. As shown in FIG. 5, the frame 410 of the present embodiment may include a body 411 and an arm 412 connected to the body 411. The arm 412 may be used to carry a propulsion device 413, which may include a rotor 413a and a motor 413b that may be used to drive the rotation of the rotor 413a.

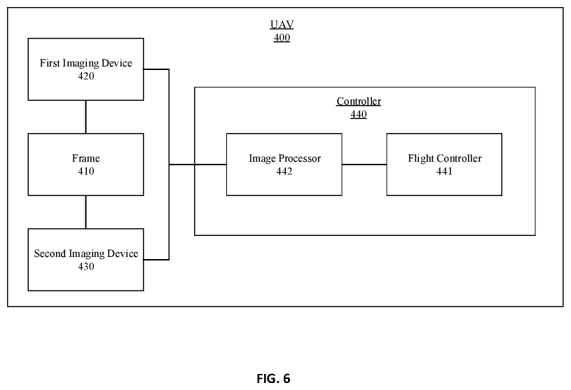

FIG. 6 is a schematic structural diagram of the UAV according to another embodiment of the present disclosure. As shown in FIG. 6, on the basis of the embodiment shown in FIG. 4, in the present embodiment, the controller 440 may further include a flight controller 441 and an image processor 442.

The flight controller 441 may be used to control a flight trajectory of an aircraft.

The image processor 442 may be communicatively connected to the first imaging device 420, the second imaging device, 430, and the flight controller 441 for processing the images.

That is, the first imaging device 420 and the second imaging device 430 may transmit the capture images to the image processor 442. The image processor 442 may identify the image of the occluding object in each image and merge the images based on the image of the occluding object in each image to obtain the merged image without the occluding object.

In one embodiment, the image processor 442 may be specifically used to acquire a partial image corresponding to the image of the occluding object in each image of the N images; and obtain the merged image by merging the N images by replacing the corresponding image of the occluding object with the partial image.

In one embodiment, the image processor 442 may be specifically used to acquire the same image portion of any two images of the N images; and obtain the partial image corresponding to the image of the occluding object of another image in one image based on a positional relationship between the same image portion and the image of the occluding object in the any two images.

In one embodiment, the first imaging device 420 and the second imaging device 430 may be used to capture images at the same time and transmit the images captured at the same time to the controller 440, such as the image processor 442.

In addition, the first imaging device 420 and the second imaging device 430 may be used to capture images at the same heading angle and transmit the images captured at the same heading angle to the controller 440, such as the image processor 442.

In one embodiment, the image of the occluding object may include a portion or all of an image of one or more components of the UAV.

In one embodiment, the components may include one or more of the following types: a rotor, an arm, a stand, and a body.

The UAV of the present embodiment may be used to perform the technical solutions provided in the foregoing method embodiments of the present disclosure. The implementation principles and technical effects thereof are similar, and details are not described herein again.

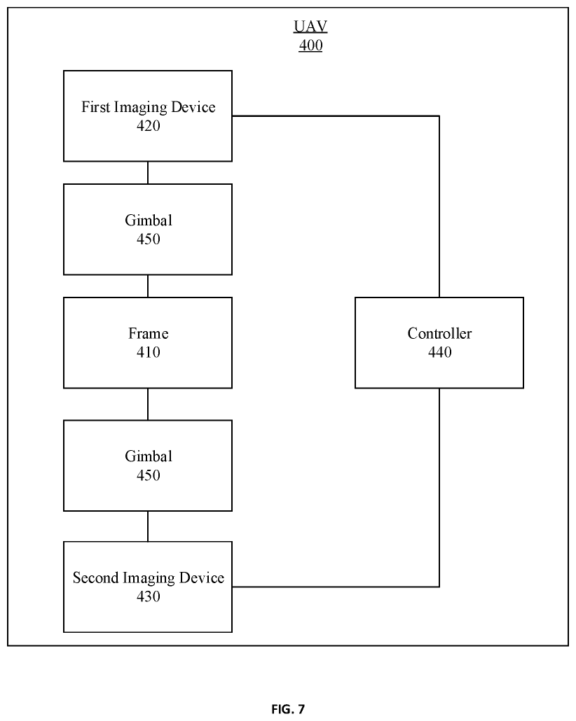

FIG. 7 is a schematic structural diagram of the UAV according to still another embodiment of the present disclosure. As shown in FIG. 7, based on any one of the embodiments shown in FIGS. 4-6, in the present embodiment, the UAV 400 may further include a gimbal 450. Further, the first imaging device 420 may include M imaging devices, the second imaging device 430 may include K imaging devices, and M and K may be integers greater than or equal to 1. Correspondingly, the gimbal 450 may include N gimbals, where N may equal M+K. Furthermore, the M number of first imaging devices and the K number of second imaging devices may be respectively carried on the N number of gimbals of the UAV. In FIG. 7, the first imaging device and the second imaging device are respectively illustrated as one imaging device. Correspondingly, the gimbals in FIG. 7 are illustrated as two gimbals, but the present embodiment is not limited thereto.

In one embodiment, the N number of gimbals 450 may be arranged on the UAV around the center of the body of the UAV.

In one embodiment, the M number of the N number of gimbals 450 may be arranged at the top of the UAV, and K number of the N number of gimbals 450 may be arranged at the bottom of the UAV.

In one embodiment, the UAV of the present embodiment may further include an image transmission device. The image transmission device may be communicatively connected to the controller 440. Further, the transmission device may be used to transmit merged image obtained by the controller 440 to a remote control device. The remote control device may be used to display the merged image on the display interface. The display interface may be a part of the remote control device for controlling the flight of the UAV.

The UAV of the present embodiment may be used to perform the technical solutions provided in the foregoing method embodiments of the present disclosure. The implementation principles and technical effects thereof are similar, and details are not described herein again.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A method for merging images, comprising:
capturing N images by using N imaging devices of a UAV, N being an integer greater than 1;
identifying an image of an occluding object in each image; and
merging the N images based on the image of the occluding object in each image to obtain a merged image without the occluding object.

2. The method of claim 1, further includes:
acquiring a partial image corresponding to the image of the occluding object in each image of the N images; and
obtaining the merged image by merging the N images and by replacing the images of the occluding object with the corresponding partial images.

3. The method of claim 2, further includes:
acquiring an identical image portion of two of the N images;
obtaining the partial image corresponding to the image of the occluding object of another image in one of the images based on a positional relationship between the identical image portion and the image of the occluding object in the two images.

4. The method of claim 1, wherein the N images are images captured by the N imaging devices at the same time; and the N images are images captured by the N imaging devices at the same heading angle.

5. The method of claim 1, wherein the image of the occluding object includes a portion or all of an image of one component of the UAV.

6. The method of claim 5, wherein the components include one of a rotor, an arm, a stand, and a body.

7. The method of claim 1, wherein the N imaging devices are respectively carried on N gimbals of the UAV.

8. The method of claim 7, wherein the N gimbals are disposed on the UAV around a center of a body of the UAV.

9. The method of claim 7, wherein a number of the N gimbals are disposed at a bottom of the UAV, and other the gimbals are disposed at a top of the UAV.

10. The method of claim 1, further includes:
displaying the merged image on a display interface.

11. A UAV, comprising:
a frame;
a first imaging device disposed at a top of the frame for capturing images;
a second imaging device disposed at a bottom of the frame for capturing images; and
a controller being communicatively connected to the first imaging device and the second imaging device,
wherein the first imaging device and the second imaging device are configured to transmit captured images to the controller; the controller is configured to identify an image of an occluding object in each image, and merge the images based on the image of the occluding object in each image to obtain a merged image without the occluding object.

12. The UAV of claim 11, wherein the controller includes a flight controller and an image processor; the flight controller is configured to control a flight trajectory of the UAV; and the image processor is communicatively connected to the first imaging device, the second imaging device, and the flight controller for processing the images.

13. The UAV of claim 11, wherein the frame includes a body and an arm connected to the body, the arm is configured to carry a propulsion device, and the propulsion device includes a rotor and a motor for driving the rotor to rotate.

14. The UAV of claim 12, wherein the image processor is configured to acquire a partial image corresponding to the image of the occluding object in each image of the N images; and obtain the merged image by merging the N images and by replacing the images of the occluding object with the corresponding partial images.

15. The UAV of claim 14, wherein the image processor is configured to acquire an identical image portion of two images of the N images; and obtain the partial image corresponding to the image of the occluding object of another image in one of the images based on a positional relationship between the identical image portion and the image of the occluding object in the two images.

16. The UAV of claim 11, wherein the first imaging device and the second imaging device are configured to capture images at the same time and transmit the images captured at the same time to the controller; and the first imaging device and the second imaging device are configured to capture images at a same heading angle and transmit the images captured at the same heading angle to the controller.

17. The UAV of claim 11, wherein the image of the occluding object includes a portion or all of an image of a component of the UAV.

18. The UAV of claim 17, wherein the components include one of a rotor, an arm, a stand, and a body.

19. The UAV of claim 11, wherein the first imaging device includes M first imaging devices and the second imaging device includes K second imaging devices, M and K being integers greater than or equal to 1;
the UAV further includes N gimbals; and
the M first imaging devices and the K second imaging devices are respectively carried on the N gimbals, and N=M+K.

20. The UAV of claim 19, wherein the N gimbals are disposed on the UAV around the center of a body of the UAV,
or, wherein M number of the N gimbals are disposed at a top of the UAV, and K number of the N gimbals are disposed at a bottom of the UAV.
